(19) United States
(12) Patent Application Publication
(10) Pub. No.: US 2006/0263581 A1
(43) Pub. Date: Nov. 23, 2006

(54) Insulated conductive particles and an anisotropic conductive film containing the particles

(76) Inventors: Jin Gyu Park, Seoul (KR); Jung Bae Jun, Gunpo-si (KR); Tae Sub Bae, Suwon-si (KR); Jae Ho Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/429,390

(22) Filed: May 5, 2006

Related U.S. Application Data
(63) Continuation-in-part of application No. PCT/KR04/02847, filed on Nov. 5, 2004.

(30) Foreign Application Priority Data
Nov. 6, 2003 (KR) 10-2003-0078316

(51) Int. Cl. B32B 7/02; B32B 5/16; H01B 1/00

(52) U.S. Cl. 428/212; 428/323; 427/214; 427/58; 257/746; 252/500; 252/512; 257/E23.01

(57) ABSTRACT

The insulated conductive particles of the present invention comprise a resin core 41 having an average particle size of 1 to 10 μm, a Ni layer 42 coated on the surface of the resin core with a thickness of 0.01-0.1 μm, an Au layer 43 coated on the Ni layer with a thickness of 0.03-0.3 μm, and an inorganic insulating layer 44 coated on the Au layer with a thickness of 0.05-1 μm. An anisotropic conductive film of the present invention comprises the insulated conductive particles in the number of 10,000-80,000 per square millimeter (mm²).

### CROSS-REFERENCE TO RELATED APPLICATIONS

This application is a continuation-in-part of International Application No. PCT/KR2004/002847, filed on Nov. 5, 2004, under the Patent Cooperation Treaty (PCT), designating the U.S., the disclosure of which is incorporated herein by reference in its entirety.

### BACKGROUND OF THE INVENTION

1. Field of the Invention

The present invention relates to an anisotropic conductive film forming composition. More particularly, the present invention relates to an anisotropic conductive film forming composition including insulated conductive particles.

2. Description of the Related Technology

Recently, an anisotropic conductive film (ACF) has been widely used to electrically connect electronic components. An anisotropic conductive film is typically interposed between two circuits and provides multiple electrical connections between the two circuits. For example, an anisotropic conductive film is interposed between a display pixel array and an array of circuits facing the display pixel array.

For example, in a typical LCD packaging technique, such as a COF (chip-on-film) method, an anisotropic conductive film serves as an electrical connection medium between an LCD panel and a printed circuit board (PCB). An anisotropic conductive film may also be used for connection of a flexible printed circuit board (FPC) to a PCB. In addition, for the next generation packaging process, it has been proposed to connect a driver IC bare chip to an ITO pattern formed on a LCD glass panel directly by means of ACF.

### SUMMARY OF CERTAIN INVENTIVE ASPECTS

An aspect of the invention is to provide an insulated conductive particle having excellent reliability in electrical connection as well as reliability in insulation.

Another aspect of the invention provides an anisotropic conductive film forming composition. The composition comprises: a matrix comprising a film forming composition; and a plurality of particles dispersed in the matrix, each particle comprising: a core comprising a resin, a first layer coated over the core, the first layer comprising a first conductive material, a second layer coated over the first layer, the second layer comprising a second conductive material different from the first conductive material, and an insulating material coated over the second layer.

In the composition, the matrix may comprise: a body-forming resin; a polymerizable compound configured to cross-link the body-forming resin upon polymerization; and a polymerization initiator. The first layer may comprise Ni. The second layer may comprise Au. The first layer may have a thickness between about 0.01 μm and about 0.1 μm. The second layer may have a thickness between about 0.03 μm and about 0.3 μm. The core may have a diameter between about 1 μm and about 10 μm. The core may comprise at least one material selected from the group consisting of divinylbenzene, 1,4-divinyloxybutane, divinylsulfone, diallyl phthalate, diallylacrylamide, triallyl isocynurate, triallyltrimelitate, (poly)ethylene glycol di(meth)acrylate, (poly)propylene glycol di(meth)acrylate, pentaerythritol tetra(meth)acrylate, pentaerythlytol tri(meta)acrylate, pentaerythritol di(meth)acrylate, trimethylolpropane tri(meta)acrylate, dipentaerythritol hexa(meth)acrylate, dipentaerythritol penta(meth)acrylate, and glycerol tri(meta)acrylate.

The insulating material may comprise silica (SiO₂). The insulating material may have a thickness between about 0.05 μm and about 1 μm. The insulating material may be at least partially coated over the second layer. The insulating material may be coated over about 0.1% to about 100% of the surface of the second layer. The particles may be substantially spherical or substantially elliptical. The particles may have a diameter between about 1.1 μm and about 10.5 μm.

Another aspect of the invention provides an anisotropic conductive film comprising the composition described above. In the film, the number of the particles in the film may be about 10,000 to about 80,000 per square millimeter.

Yet another aspect of the invention provides a method of making particles for use in an anisotropic conductive film. The method comprises: providing a core comprising a resin; forming a first layer coating over the core, the first layer comprising a first conductive material; forming a second layer coating over the first layer, the second layer comprising a second conductive material; and forming an insulating material over the second layer so as to at least partially cover the surface of the second layer. The insulating layer may comprise silica and at least one of 3-mercaptopropyl triethoxysilane and 3-mercaptopropyl triethoxysilane.

Yet another aspect of the invention provides an electronic device comprising: a first circuit comprising a first electrode; a second circuit comprising a second electrode; and an anisotropic conductive film interconnecting the first and second circuits, the anisotropic conductive film comprising a polymer resin and at least one anisotropic conductive connection between the first and second electrodes, the at least one anisotropic conductive connection comprising at least one particle, the at least one particle comprising: a core comprising a resin; a first layer coated over the core, the first layer comprising a first conductive material; and a second layer coated over the first layer, the second layer comprising a second conductive material different from the first conductive material, at least one of the first and second conductive materials of a single particle electrically contacts both the first and second electrodes.

The device may comprise a display device. The at least one particle participating in the at least one anisotropic conductive connection may further comprise an insulating material partially coating over the second layer. The anisotropic conductive film may further comprise at least one particle that do not electrically contact both the first and second electrodes, wherein the at least one particle may comprise: a core comprising a resin, a first layer coated over the core, the first layer comprising a first conductive material, a second layer coated over the first layer, the second layer comprising a second conductive material different from the first conductive material, and an insulating material coated over the second layer.

The second conductive material electrically may contact both the first and second electrodes. Two opposingly located portions of the single particle may contact the first and second electrodes.

Another aspect of the invention provides a method of making an electronic device. The method comprises: providing an intermediate product of an electronic device, the intermediate device comprising first and second electrically conductive portions; placing the composition described above between the first and second electrically conductive portions; anisotropically aligning at least some of the particles between the first and second electrically conductive portions; and polymerizing at least part of the polymerizable compound.

Another aspect of the invention provides insulated conductive particles, each of which comprises a resin core having an average particle size of 1 to 10 μm, a Ni layer coated on the surface of the resin core with a thickness of 0.01-0.1 μm, an Au layer coated on the Ni layer with a thickness of 0.03-0.3 μm, and an inorganic insulating layer coated on the Au layer with a thickness of 0.05-1 μm. The coverage of the inorganic insulating layer on the surface of Au layer is 0.1-100%. In addition, an anisotropic conductive film may comprise the insulated conductive particles in an amount of 10,000-80,000 per square millimeter (mm²).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view showing a connected state where an anisotropic conductive film containing conductive particles is interposed between a liquid crystal display (LCD) and a driver IC.

FIG. 2(a) is a cross-sectional view showing a substantially entirely insulated conductive particle according to one embodiment.

FIG. 2(b) is a cross-sectional view showing a partially insulated conductive particle according to another embodiment.

FIG. 3(a) is a micrograph, taken with a scanning electron microscope, of substantially entirely insulated conductive particles of FIG. 2(a).

FIG. 3(b) is a micrograph, taken with a scanning electron microscope, of the partially insulated conductive particles of FIG. 2(b).

FIG. 4(a) is a cross-sectional view showing a state before connecting a liquid crystal display (LCD) to a driver IC, using an anisotropic conductive film which contains particles of FIG. 2(a) therebetween.

FIG. 4(b) is a cross-sectional view showing a state before connecting a liquid crystal display (LCD) to a driver IC, using an anisotropic conductive film which contains particles of FIG. 2(b) therebetween.

FIG. 5(a) is a cross-sectional view showing a state after connecting a liquid crystal display (LCD) to a driver IC by the anisotropic conductive film of FIG. 4(a).

FIG. 5(b) is a cross-sectional view showing a state after connecting a liquid crystal display (LCD) to a driver IC by the anisotropic conductive film of FIG. 4(b).

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

An anisotropic conductive film is typically formed by curing an anisotropic conductive film forming composition. The composition includes a body-forming resin, a polymerizable compound, a polymerization initiator, and conductive particles. Typically, the composition is in a film form, and is positioned between two electrodes. Then, a pressure is applied onto one electrode against the other while heating the film. During this process, conductive particles dispersed in the resin form anisotropic electrical connections between the two electrodes and the polymerizable compound goes through polymerization initiated by the polymerization initiator. The polymerizable compound cross-links the body-forming resin, which sustains the anisotropic electrical connections. Typically, the anisotropic conductive film is conductive only in a direction extending between the electrodes through the conductive particles, while the film is insulative in a direction perpendicular to the direction extending between the electrodes. In the context of this document, an anisotropic conductive film (ACF) may interchangeably refer to either a film-shaped anisotropic conductive film forming composition or a cured film having anisotropic connections.

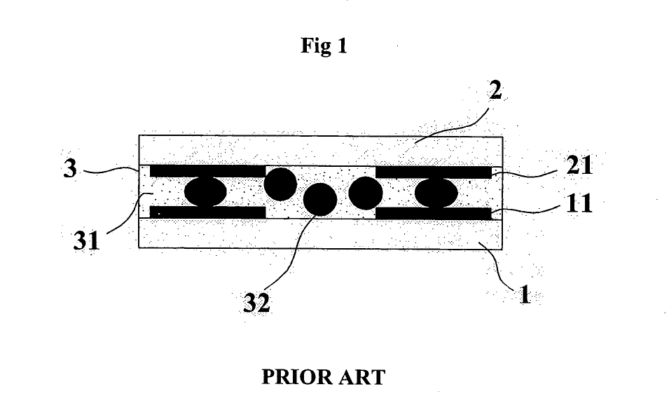

FIG. 1 is a cross-sectional view showing an anisotropic conductive film (ACF) 3 containing conventional conductive particles 32. The ACF 3 is interposed between a liquid crystal display 1 and a driver IC 2. In the ACF, an electrical shorting between the electrodes may occur due to aggregation of the particles 32.

The conductive particles 32 are dispersed in an adhesive material 31, which is electrically insulative. With the recent technical development, electrically conductive bumps 21 of driver IC or patterns 11 of a circuit board become finer. Accordingly, the size of the conductive particles becomes smaller and the density of the conductive particles increases. Electrical shorting tends to occur due to clustering of and/or contacts between the conductive particles 32. This problem adversely affects reliability of electrical connection.

In order to prevent such occurrence of shorting, various methods have been proposed. Japanese Patent Application Publication Nos. 62-40183, 62-176139, 3-46774, 4-174980, 7-105716, 2001-195921 and 2003-313459 disclose a method of coating a surface of a conductive particle with an insulating material, such as an insulative resin, using a method such as micro-encapsulation, spray-drying, coacervation, electrostatic coating, metathesis, or hybridization. Moreover, Japanese Patent Application Publication No. 2-204917 discloses a conductive particle having an electrically insulating layer on its surface made by coating an insulative metal oxide layer. Japanese Patent Application Publication Nos. 60-117504, 6-333965, 6-349339 and 2001-164232 disclose an anisotropic conductive adhesive sheet containing a conductive particle including an insulative organic or inorganic particles and an insulative fibrous filler to prevent aggregation of the conductive particles and hence to improve reliability in the electrical connection.

Anisotropic conductive films according to various embodiments of the invention prevent electrical connections of conductive particles in undesired directions while improving reliability in electrical connection in desired directions.

In one embodiment, an anisotropic conductive film forming composition includes a matrix comprising a film forming composition, and a plurality of particles dispersed in the matrix. Although various forms of conductive particles may be contained, all or at least part of the particles have a core comprising a resin, a first layer coated over the core, a second layer coated over the first layer, and an insulating material coated over the second layer. The first layer includes a first conductive material, and the second layer includes a second conductive material different from the first conductive material. The insulating layer may partially or entirely cover the second layer. In some embodiments, between the core and the insulating layer, there may be one or more additional conductive material layers.

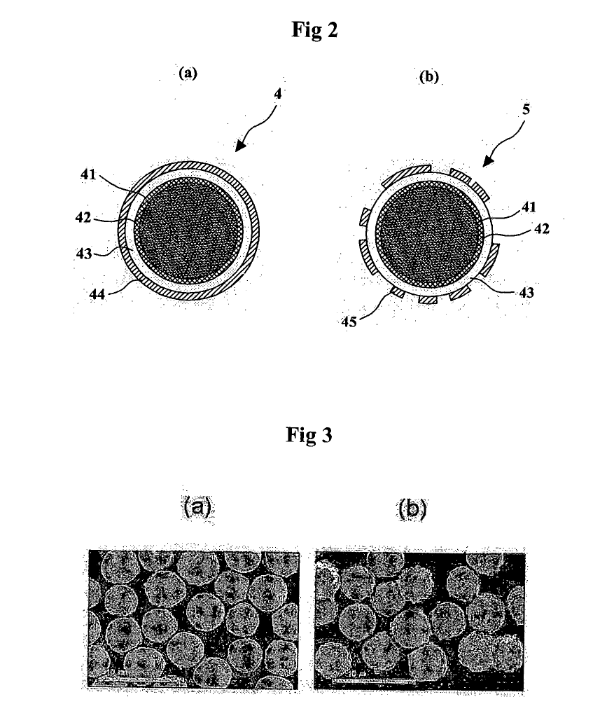

FIG. 2 is a cross-sectional view showing an insulated conductive particle according to embodiments. FIG. 2 illustrates (a) a substantially entirely insulated conductive particle, and (b) a partially insulated conductive particle. The insulating layer may cover about 0.1% to 100% of the surface of the second layer. For example, the insulating layer may cover 0.1%, 1%, 5%, 10%, 15%, 20%, 25%, 30%, 35%, 40%, 45%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of the surface of the second layer.

In the illustrated embodiments, each of the insulated conductive particles (a), (b) includes a resin core 41, a first conductive layer 42 coated on the surface of the resin core, a second conductive layer 43 coated on the first conductive layer, and an inorganic insulating layer 44 or 45 coated on the second conductive layer. The inorganic insulating layer 44 may cover the surface of the second layer substantially continuously, forming the substantially entirely insulated conductive particle 4, as shown in FIG. 2(a). In another embodiment, the inorganic insulating layer 45 covers the surface of the second layer discontinuously, providing the partially insulated conductive particle 5, as shown in FIG. 2(b).

In one embodiment, the resin core 41 has an average particle size of about 1 to 10 μm. The first conductive layer 42 may have a thickness of about 0.01-0.1 μm. The second conductive layer 43 may have a thickness of about 0.03-0.3 μm. The inorganic insulating layer 44 or 45 may have a thickness of about 0.05-1 μm, optionally about 0.1-0.5 μm.

The insulated conductive particles can have excellent reliability in electrical connection and in insulation. In the case of the partially insulated conductive particle 5, the electrical connection can be established by direct contact between non-insulated portions of the second layer and an electrode. Also, the insulating layer that partially covers the second layer may be peeled off or broken to expose the second layer to contact the electrode. In the case of the substantially entirely insulated particle 4, portions of the insulating layer may be broken or peeled off to expose the underlying second layer while the ACF forming composition is pressed between two electrodes. These configurations provide electrical connection between electrodes while preventing electrical connections in a direction other than between the two electrodes.

In one embodiment, the resin cores 41 may include monodisperse styrenic or acrylic cross-linked polymer. The resin core may have a spherical or elliptical shape. The resin cores 41 may have an average particle size of about 1 μm to about 10 μm. For example, the diameter of the resin core 41 may be about 0.5, 1, 2, 3, 4, 5, 6, 7, 8, 9, 10, 1, or 12 μm. The resin particles may be formed from a radically polymerizable compound. Examples of such compound include, but are not limited to, divinylbenzene, 1,4-divinyloxybutane, divinylsulfone, allyl compound such as diallyl phthalate, diallylacrylamide, triallyl isocynurate, triallyltrimelitate, etc, and (poly)alkylene glycol di(meth)acrylates such as (poly)ethylene glycol di(meth)acrylate, (poly)propylene glycol di(meth)acrylate, pentaerythritol tetra(meth)acrylate, pentaerythlytol tri(meta)acrylate, pentaerythritol di(meth)acrylate, trimethylolpropane tri(meta)acrylate, dipentaerythritol hexa(meth)acrylate, dipentaerythritol penta(meth)acrylate and glycerol tri(meta)acrylate.

In the illustrated embodiment, the first conductive layer 42 comprises a Ni layer 42. In one embodiment, the thickness of the Ni layer is about 0.01-0.1 μm. The first layer may be coated, using wet electroless plating which is also referred to as autocatalytic plating. Electroless plating is a plating process which involves deposition without any current applied. The skilled artisan will appreciate conditions and procedures of electrodeless plating. In other embodiments, the first layer may be formed of any other conductive material, including Cu, suitable for electroless plating on the resin core. Functionally, the first layer may serve as a seed which facilitates deposition of the material of the second conductive layer.

On the surface of the first conductive layer 42, the second conductive layer 43 is coated in a thickness of about 0.03 μm to about 0.3 μm. The second conductive layer 43 includes a highly conductive material, for example, Au. In other embodiments, the second conductive layer 43 may include other conductive materials, for example, Ag, Cu, Al, or alloys of two or more of the foregoing. In embodiments, the second conductive layer is also formed, using electroless plating.

The insulating layer 44 or 45 is coated over the Au layer. In one embodiment, the insulating layer 44 or 45 includes an inorganic material such as silica (SiO₂). The insulating layer 44 or 45 may have a thickness between about 0.05-1 μm, optionally about 0.1-0.5 μm.

The insulating layer 44 or 45 may be coated over the Au layer as follows. First, the resin cores coated with the Ni and Au layers are dispersed in an organic solvent to form a suspension. In embodiments, the suspension is substantially free of water. Then, a compound that can form a bonding on the surface of the second conductive layer is added to the suspension. In some embodiments, compounds having a thiol group (—SH) can be used for that purpose. Examples of such compounds include silane compounds, such as 3-mercaptopropyl trimethoxysilane and 3-mercaptopropyl triethoxysilane. The silane compounds form a thin layer on the surface of the second conductive (Au) layer. The thin layer typically comprises a single layer of the compound and often called a self-assembly mono layer. After the thin layer is formed, an insulating material that can form a bonding with or be bound to the compound of the thin layer is applied to form an insulating layer over the thin layer. For example, silica (SiO₂) layer used to form the insulating layer. In one embodiment, the silica layer is formed using a sol-gel reaction. The thickness of the inorganic insulating layer can be controlled by the concentration of the silane compound in the organic solvent and the amount of the coated resin particles.

In addition, the coverage of the insulating layer over the Au layer may also be controlled. The continuity of the insulating layer depends on the reaction conditions between the silane compound and the coated resin cores. For example, the coating coverage of the insulating layer may be controlled by adjusting the concentration of 3-mercaptopropyl trimethoxysilane or 3-mercaptopropyl triethoxysilane compound.

In one embodiment, the amount of the insulated conductive particles in the anisotropic conductive film forming composition is about 10,000 to 80,000 per square millimeter (mm²), optionally about 30,000-60,000 per square millimeter (mm²). In one embodiment, the amount of the insulated conductive particles is about 3-20% by weight with reference to a total weight of the ACF forming composition.

As described above, the ACF forming composition also includes the matrix comprising the film forming composition in which the insulated conductive particles are dispersed. In one embodiment, the film forming composition includes a polymerizable compound, a body-forming resin, and a polymerization initiator. In certain embodiments, the film forming composition may include other additives to improve dispersion or film formation.

In one embodiment, the polymerizable compound is an epoxy-based resin. An exemplary epoxy-based resin is a polyepoxy resin which contains more than 2 epoxy groups in one molecule. Examples of the epoxy-based resin includes, but are not limited to: a novolak resin such as phenol novolak and cresol novolak; a polyphenol such as bisphenol A, bisphenol F and bishydroxy phenyl ether; a polyalcohol such as ethylene glycol, neopentyl glycol, glycerin, trimethylolpropane, and polypropylenegylcol; a polyamino compound such as ethylene diamine, triethylene tetra-amine, and aniline; a poly carboxylic compound such as phthalic acid and isophthalic acid. The polymerizable compound may include a mixture of two or more of the foregoing.

The body-forming resin is chosen from resins which can easily form a film and do not react with the polymerization initiator. Examples of the body-forming resin include, but are not limited to: an acrylic resin such as acrylate resin, ethylene-acrylate copolymer, ethylene-acrylic acid copolymer and so on; an olefinic resin such as ethylene resin, ethylene-propylene copolymer and so on; a rubber such as butadiene resin, acrylonitrile-butadiene copolymer, styrene-butadiene block copolymer, styrene-butadiene-styrene block copolymer, carboxylated styrene ethylene butadiene styrene block copolymer, nitrile-butadiene rubber, styrene butadiene rubber, chloroprene rubber and so on; a vinyl based resin such as vinyl butyral resin, vinylform resin and so on; an ester resin such as polyester, cyanate ester and so on; a phenoxy resin, a silicon rubber, or a urethan resin; or a mixture of two or more of the foregoing.

The polymerization initiator (or curing agent) includes a compound which contains more than two of activated hydrogen in one molecule, for examples imidazoles, isocyanates, amines, anhydrides and a mixture of the foregoing.

FIG. 3(a) is a micrograph, taken with a scanning electron microscope (S.E.M), of substantially entirely insulated conductive particles 4. FIG. 3(b) is micrograph, taken with a scanning electron microscope (S.E.M), of the partially insulated conductive particles 5.

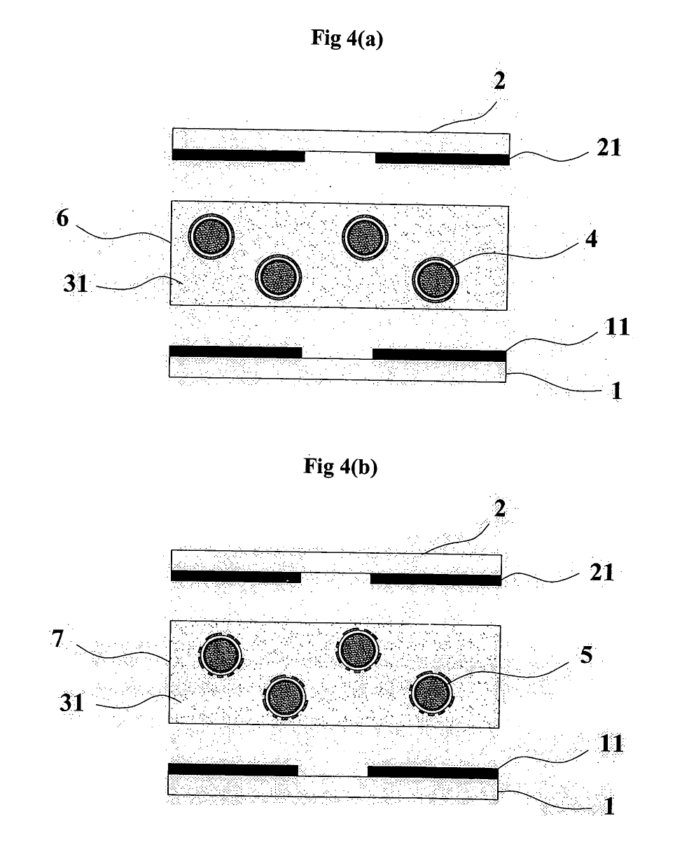

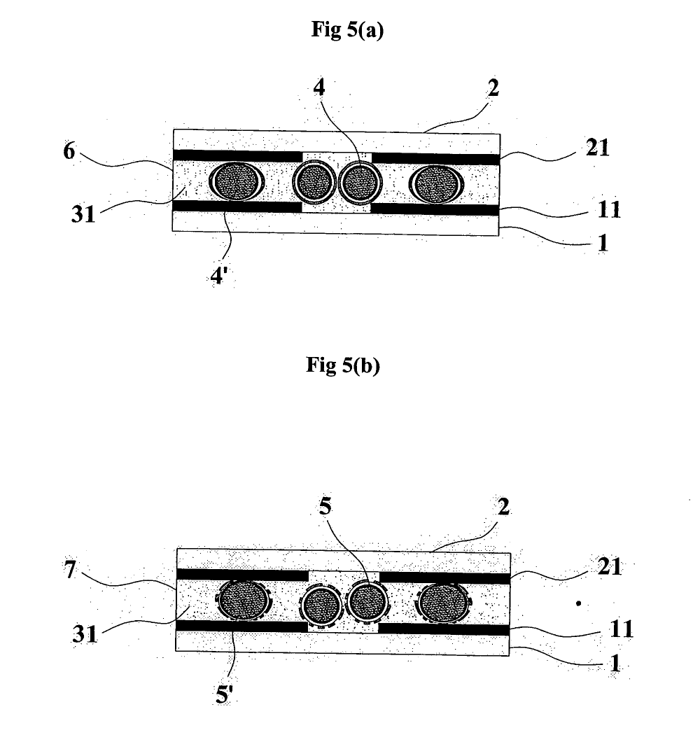

FIG. 4(a) is a cross-sectional view showing a state before connecting a liquid crystal display (LCD) to a driver IC by interposing an anisotropic conductive film which contains substantially entirely insulated conductive particles therebetween. FIG. 4(b) is a cross-sectional view showing a state before connecting a liquid crystal display (LCD) to a driver IC by interposing an anisotropic conductive film which contains the partially insulated conductive particles therebetween. FIG. 5(a) is a cross-sectional view showing a state after connecting a liquid crystal display (LCD) to a driver IC by interposing the anisotropic conductive film of FIG. 4(a). FIG. 5(b) is a cross-sectional view showing a state after connecting a liquid crystal display (LCD) to a driver IC by interposing an anisotropic conductive film of FIG. 4(b).

As shown in FIGS. 4(a) and 4(b), the anisotropic conductive film (ACF) containing the insulated conductive particles is interposed between two boards to connect wiring patterns 11 of an LCD 1 to a bump electrode 21 of the driver IC 2. Then, the boards are pressed against each other with the ACF sandwiched therebetween. The ACF is then attached to the boards by curing of the polymerizable compound. For example, the curing of a thermosetting polymerizable compound is initiated by heating and pressing. As shown in FIG. 5, the substantially insulated conductive particle establishes electrical connection by a crushing 4′ between the bump electrode and the pattern or by a direct contact 5′ of a conductive layer on a surface of a non-insulated portion. Since the insulated conductive particles have an insulating layer at their outermost surface, electrical shorting between the bumps is prevented from occurring, thereby increasing reliability in insulation. Further, since the insulated conductive particle establishes electrical connection by crushing 4′ or by a direct contact 5′ of a conductive layer on the surface of the non-insulated portion, reliability in electrical connection can be maintained.

Electronic Devices

Another aspect of the invention provides an electronic device including an anisotropic conductive film. In one embodiment, the electronic device includes a first circuit, a second circuit, and an anisotropic conductive film interconnecting the first and second circuits. The anisotropic conductive film includes a cross-linked polymer resin and at least one anisotropic conductive connection between electrodes of the circuits.

The electronic device may include, but is not limited to consumer electronic products, electronic circuits, electronic circuit components, parts of the consumer electronic products, electronic test equipments, etc. The consumer electronic products may include, but are not limited to, a mobile phone, a telephone, a television, a computer monitor, a computer, a hand-held computer, a personal digital assistant (PDA), a microwave, a refrigerator, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi functional peripheral device, a wrist watch, a clock, etc. Further, the electronic device may include unfinished products.

In one embodiment, the electronic device described above may be made by the following method. First, a first part of an electronic device having a first electrode is provided. Then, an ACF is provided onto the first part to cover the first electrode. Next, a second part of the electronic device having a second electrode is provided over the first part. The second part is positioned so that the second electrode is aligned above the first electrode with the ACF interposed between the electrodes. Then, pressure is applied onto the second part against the first part. In addition, heat may be applied to the ACF. In certain embodiments, the ACF may be pressed and/or heated to a temperature of between about 60° C. and about 200° C., optionally between about 180° C. and about 200° C., for about 0.5 to about 2 seconds before being provided between the electrodes.

During this process, some of the conductive particles are positioned between the electrodes and provide anisotropically electric connection between the electrodes. In addition, the polymerization initiator initiates polymerization of the polymerizable compound. As a result, cross-links are formed between the body-forming resins. Since the polymerizable compounds generate thermosetting polymers and cross-links, the anisotropic electric connection maintains as the thermosetting polymers cure. This configuration maintains the established electrical connection between the electrodes of the electronic device.

The invention may be better understood by reference to the following examples which are intended for the purpose of illustration and are not to be construed as in any way limiting the scope of the present invention, which is defined in the claims appended hereto.

### EXAMPLES

Conductive particles were prepared as follows. To a four-neck reactor of 500 ml was added 10 g of conductive particles (24GNR4.0-MX, 4 μm, commercially available from NCI company), 3 g of γ-mercaptopropyl trimethoxysilane and 200 g of ethanol. The solution was agitated for 20 hours at the rate of 100 rpm, maintaining the temperature at 50° C. to lead the thiol-group of γ-mercaptopropyl trimethoxysilane to form a self-assembly with an Au layer on the surface of the conductive particles. The mixture was heated up to 60° C. Then, 5 g of nitric acid was added to provide a coupling reaction for four hours between silanes to introduce a silica layer on the surface of Au. After the reaction was over, the particles coated with an insulating layer were recovered, using a magnet, washed four times with pure water and subjected to a centrifugal separation.

The anisotropic conductive films containing insulated conductive particles were prepared as follows: 15 parts by weight of Bisphenol A type epoxy resin (epoxy equivalent 6000) and 7 parts by weight of 2-methyl imidazole as a curing agent were dissolved in a solution prepared by mixing tolene and methylethyl ketone. To the mixture, 25,000 of insulated conductive particles per square millimeter (mm²) and a silane coupling agent were dispersed. The resulting mixture was coated on a releasing PET film and then was dried to form a film with a thickness of 25 μm. The conductive particle which comprises a polydivinyl benzene particle with a particle size of 5 μm, coated with a Ni layer, an Au layer and a silica insulating layer in order on the surface of the resin was used.

The anisotropic conductive films thus produced were evaluated for reliability in electrical connection and reliability in insulation of an IC chip as described below.

### Examples 1-6

The reliability in electrical connection was evaluated at bump height of 40 μm with an IC chip size of 6 mm×6 mm using a circuit board of BT resin with a thickness of 0.7 mm formed a wiring pattern with a thickness of 8 μm (Cu—Au plating) at a pitch of 150 μm. The anisotropic conductive films thus produced were imposed between the IC chip and the circuit board, followed by heating and pressed under the condition of 200° C. and 400 kg/cm² for 20 seconds to provide a sample in a contact state. The sample was aged at 80° C. at a relative humidity of 85% RH for 1,000 hours, and tested to determine reliability in electrical connection by value of an increase of connection resistance

Next, the reliability in insulation was evaluated with a bump size of 70 μm×100 μm at bump height of 20 μm, with an IC chip size of 6 mm×6 mm using a transparent board formed a wiring pattern by indium tin oxide at a pitch of 80 μm and with a line of 70 μm. In this case, whether a shorting occurs or not was observed by a transparent board with a microscope. The results are shown in Table 1.

TABLE 1

| | Examples | | | | | |
|---|---|---|---|---|---|---|
| | 1 | 2 | 3 | 4 | 5 | 6 |
| Number of the insulated | 20,000 | 30,000 | 30,000 | 40,000 | 40,000 | 50,000 |
| conductive particles per square | | | | | | |
| millimeter (mm²) | | | | | | |
| Size of the insulated conductive | 5.0 | 5.0 | 4.5 | 4.5 | 4.0 | 4.0 |
| particles (μm) | | | | | | |
| Thickness of outermost | 0.05 | 0.05 | 0.05 | 0.05 | 0.05 | 0.05 |
| insulating layer | | | | | | |
| (Thickness of outermost layer/ | | | | | | |
| particle size of substrate resin | | | | | | |
| including a Ni layer | | | | | | |
| and an Au layer) | | | | | | |
| Area of IC bump (μm²) | 3,000 | 3,000 | 3,000 | 3,000 | 3,000 | 3,000 |
| Reliability in electrical connection | Δ | ⊚ | ⊚ | ⊚ | ⊚ | ⊚ |

an increase of connection resistance value
⊚: not more than 0.1 Ω, Δ: more than 0.1 Ω not more than 0.3 Ω, X: more than 0.3 Ω

| | | | | | | |
|---|---|---|---|---|---|---|
| Reliability in insulation | ⊚ | ⊚ | X | ⊚ | ⊚ | ⊚ |

⊚: more than 10¹⁰ Ω, X: not more than 10 ¹⁰Ω

### Examples 7-9

Example 7 was conducted in the same manner as in Example 2 except that a conventional conductive particle was used instead of the insulated conductive particles of the above embodiments.

Example 8 was conducted in the same manner as in Example 4 except that a conductive particle using an acryl resin as an insulative resin was used instead of the insulated conductive particles of the embodiments.

Example 9 was conducted in the same manner as in Example 6 except that a conductive particle using PVA resin as an insulative resin was used instead of the insulated conductive particles of the embodiments. The results are shown in Table 2.

TABLE 2

| | Examples | | |
|---|---|---|---|
| | 7 | 8 | 9 |
| Number of the insulated conductive | 30,000 | 40,000 | 50,000 |
| particles per square millimeter(mm²) | | | |
| Insulative resin layer | — | Acryl resin | PVA resin |
| Thickness of outermost | — | 0.05 | 0.05 |
| insulating layer | | | |
| (Thickness of outermost layer/ | | | |
| size of conductive particle) | | | |
| Area of IC bump used in evaluation | 3,000 | 3,000 | 3,000 |
| for reliability in electrical | | | |
| connection(μm²) | | | |
| Reliability in electrical connection | Δ | Δ | X |

an increase of connection resistance value
⊚: not more than 0.1 Ω, Δ: more than 0.1 Ω not more than 0.3 Ω,
X: more than 0.3 Ω

| | | | |
|---|---|---|---|
| Reliability in insulation | X | X | ⊚ |

⊚: more than 10¹⁰ Ω, X: not more than 10¹⁰ Ω

As shown above, the anisotropic conductive films using insulated conductive particles of the embodiments may obtain a higher reliability in electrical connection and insulation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An anisotropic conductive film forming composition, comprising:
a matrix comprising a film forming composition; and
a plurality of particles dispersed in the matrix, each particle comprising:
a core comprising a resin,
a first layer coated over the core, the first layer comprising a first conductive material,
a second layer coated over the first layer, the second layer comprising a second conductive material different from the first conductive material, and
an insulating material coated over the second layer.

2. The composition of claim 1, wherein the matrix comprises:
a body-forming resin;
a polymerizable compound configured to cross-link the body-forming resin upon polymerization; and
a polymerization initiator.

3. The composition of claim 1, wherein the first layer comprises Ni.

4. The composition of claim 1, wherein the second layer comprises Au.

5. The composition of claim 1, wherein the first layer has a thickness between about 0.01 μm and about 0.1 μm.

6. The composition of claim 1, wherein the second layer has a thickness between about 0.03 μm and about 0.3 μm.

7. The composition of claim 1, wherein the core has a diameter between about 1 μm and about 10 μm.

8. The composition of claim 1, wherein the core comprises at least one material selected from the group consisting of divinylbenzene, 1,4-divinyloxybutane, divinylsulfone, diallyl phthalate, diallylacrylamide, triallyl isocynurate, triallyltrimelitate, (poly)ethylene glycol di(meth)acrylate, (poly)propylene glycol di(meth)acrylate, pentaerythritol tetra(meth)acrylate, pentaerythlytol tri(meta)acrylate, pentaerythritol di(meth)acrylate, trimethylolpropane tri(meta)acrylate, dipentaerythritol hexa(meth)acrylate, dipentaerythritol penta(meth)acrylate, and glycerol tri(meta)acrylate.

9. The composition of claim 1, wherein the insulating material comprises silica (SiO₂).

10. The composition of claim 1, wherein the insulating material has a thickness between about 0.05 μm and about 1 μm.

11. The composition of claim 1, wherein the insulating material is at least partially coated. over the second layer.

12. The composition of claim 1, wherein the insulating material is coated over about 0.1% to about 100% of the surface of the second layer.

13. The composition of claim 1, wherein the particles are substantially spherical or substantially elliptical.

14. The composition of claim 1, wherein the particles have a diameter between about 1.1 μm and about 10.5 μm.

15. An anisotropic conductive film comprising the composition of claim 1.

16. The film of claim 15, wherein the number of the particles in the film is about 10,000 to about 80,000 per square millimeter.

17. A method of making particles for use in an anisotropic conductive film, comprising:
providing a core comprising a resin;
forming a first layer coating over the core, the first layer comprising a first conductive material;
forming a second layer coating over the first layer, the second layer comprising a second conductive material; and
forming an insulating material over the second layer so as to at least partially cover the surface of the second layer.

18. The method of claim 17, wherein the insulating layer comprises silica and at least one of 3-mercaptopropyl triethoxysilane and 3-mercaptopropyl triethoxysilane.

19. An electronic device comprising:
a first circuit comprising a first electrode;
a second circuit comprising a second electrode; and
an anisotropic conductive film interconnecting the first and second circuits, the anisotropic conductive film comprising a polymer resin and at least one anisotropic conductive connection between the first and second electrodes, the at least one anisotropic conductive connection comprising at least one particle, the at least one particle comprising:
a core comprising a resin;
a first layer coated over the core, the first layer comprising a first conductive material; and
a second layer coated over the first layer, the second layer comprising a second conductive material different from the first conductive material, at least one of the first and second conductive materials of a single particle electrically contacts both the first and second electrodes.

20. The device of claim 19, wherein the device comprises a display device.

21. The device of claim 19, wherein the at least one particle participating in the at least one anisotropic conductive connection further comprises an insulating material partially coating over the second layer.

22. The device of claim 19, wherein the anisotropic conductive film further comprises at least one particle that does not electrically contact both the first and second electrodes, wherein the at least one particle comprises:
a core comprising a resin,
a first layer coated over the core, the first layer comprising a first conductive material,
a second layer coated over the first layer, the second layer comprising a second conductive material different from the first conductive material, and
an insulating material coated over the second layer.

23. The device of claim 19, wherein the second conductive material electrically contacts both the first and second electrodes.

24. The device of claim 19, wherein two opposingly located portions of the single particle contact the first and second electrodes.

25. A method of making an electronic device, comprising:
providing an intermediate product of an electronic device, the intermediate device comprising first and second electrically conductive portions;
placing the composition of claim 2 between the first and second electrically conductive portions;
anisotropically aligning at least some of the particles between the first and second electrically conductive portions; and
polymerizing at least part of the polymerizable compound.
